(19) United States
(12) Patent Application Publication
(10) Pub. No.: US 2019/0153184 A1
(43) Pub. Date: May 23, 2019

(54) POLYURETHANE FOAMS COMPRISING A MIXTURE OBTAINED IN THE PRODUCTION OF TOLYLENE DIISOCYANATE (TDI) AS BOTTOMS RESIDUE

(71) Applicant: COVESTRO DEUTSCHLAND AG, LEVERKUSEN (DE)

(72) Inventors: Sven MEYER-AHRENS, Leverkusen (DE); Tim LODDENKEMPER, Dormagen (DE); Chenxi ZHANG, Shanghai (CN); Liqiang LI, Shanghai (CN)

(21) Appl. No.: 16/321,923

(22) PCT Filed: Aug. 5, 2016
(86) PCT No.: PCT/CN2016/093708

§ 371 Date: Jan. 30, 2019

(51) Int. Cl. C08J 9/12; C08G 18/48; C08G 18/32; C08G 18/66; C08G 18/76; C08G 18/08; C08G 18/18

(52) U.S. Cl. CPC C08J 9/125; C08G 18/485; C08G 18/4816; C08G 18/3206; C08G 2101/005; C08G 18/7621; C08G 18/7664; C08G 18/0866; C08G 18/18; C08G 18/6677

(57) ABSTRACT

The present invention relates to a process for producing polyurethane foams, preferably moulded flexible polyurethane foams, by reacting an isocyanate component which is a mixture obtained in the production of tolylene diisocyanate as a bottoms residue, and at least one further isocyanate component with a component reactive toward isocyanates. The invention further relates to polyurethane foams produced by the process according to the invention and to the use thereof.

### CROSS-REFERENCE TO RELATED APPLICATIONS

This application is a national stage application under 35 U.S.C. § 371 of PCT/CN2016/093708, filed Aug. 5, 2016, which is incorporated by reference herein.

### FIELD

The present invention relates to a process for producing polyurethane foams, preferably moulded flexible polyurethane foams, by reacting an isocyanate component which is a mixture obtained in the production of tolylene diisocyanate as a bottoms residue, and at least one further component reactive toward isocyanates. The invention further relates to polyurethane foams produced by the process according to the invention and to the use thereof.

### BACKGROUND

The production of tolylene diisocyanate (TDI, also toluene diisocyanate) gives rise to a bottoms residue comprising, as well as monomeric TDI, oligomeric and polymeric isocyanate components, carbodiimides and ureas. In addition, as well as traces of various elements, especially of metals, organochlorine components may also be present. These residues have to date generally not been processed further to give polyurethanes or other polymeric products but utilized in an predominantly thermal manner It has now been found that, surprisingly, the TDI residue, especially that from the gas phase process, can be used for production of polyurethane foams.

In the context of an environmentally friendly setup of production processes, especially the protection of resources, it is generally desirable to put all reaction products obtained to further use and not merely to dispose of them.

An illustrative description of a distillative workup of bottoms residues from a tolylene diisocyanate production process is disclosed in patent specification U.S. Pat. No. 5,349,082. The publication neither discloses polyurethane foams nor gives any pointer that the mixtures obtained could be used as such. Moreover, this publication does not disclose which phosgenation method was used for production of tolylene diisocyanate.

One problem addressed by the present invention was that of providing polyurethane foams, especially flexible polyurethane foams, which are produced by a process in which a mixture obtained in the production of tolylene diisocyanate as a bottoms residue is used. A further problem addressed by the present invention is that of providing an isocyanate component which comprises the abovementioned bottoms residue and is suitable for production of flexible foams, preferably moulded flexible foams, characterized in that the isocyanate component, with regard to the chlorine content, meets the demands of IOS-MAT-0010 (IKEA®) or Certipur® of max. 0.07%.

### SUMMARY

This problem is solved by a process for producing polyurethane foams by reacting a component A comprising
A1 at least one polyether polyol having a functionality of 2 to 8, preferably of 2 to 6, more preferably of 3 to 4, a polyoxyethylene (EO) content of 0% to 30% by weight, preferably of 1% to 20% by weight, and an OH number according to DIN 53240 of ≥10 mg KOH/g to ≤112 mg KOH/g, preferably of ≥20 mg KOH/g to ≤40 mg KOH/g,
A2 optionally at least one polyether polyol having a functionality of 2 to 8, preferably of 2 to 6, more preferably of 3, a polyoxyethylene (EO) content of >60% by weight, preferably >70% by weight, and an OH number according to DIN 53240 of ≥10 mg KOH/g to ≤112 mg KOH/g, preferably of ≥20 mg KOH/g to ≤50 mg KOH/g,
A3 optionally at least one dispersion of a polymer in a polyether polyol, where the OH number according to DIN 53240 of the dispersion is within a range from 10 to 60 mg KOH/g and wherein the polyether polyol has a hydroxyl functionality of 2 to 6, preferably of 2 to 4, more preferably of 3, a polyoxypropylene (PO) content in an amount of 70% to 90% by weight and an EO content in an amount of 10% to 30% by weight;
A4 water and/or physical blowing agents,
A5 optionally compounds having hydrogen atoms that are reactive toward isocyanates, having an OH number of 140 mg KOH/g to 900 mg KOH/g,
A6 optionally auxiliaries and additives, preferably at least one component selected from catalysts, surface-active additions, additives, pigments or flame retardants or a combination thereof; and a component B comprising
B1 at least one bottoms residue which is obtained in tolylene diisocyanate (TDI) production, more preferably by the gas phase process, in the last distillation step; and
B2 further di- and/or polyisocyanates,
   wherein the reaction of component A with component B is conducted at an isocyanate index of 75 to 120, preferably 80 to 115, more preferably 85 to 95, and wherein all parts by weight figures for components A1 to A6 are normalized such that the sum total of parts by weight A1+A2+A3 in the composition adds up to 100 parts by weight.

The inventors of the present invention have found that, surprisingly, the distillation product of at least one bottoms residue obtained in tolylene diisocyanate (TDI) production in the last distillation step can be used for production of polyurethane foams, especially flexible moulded polyurethane foams. Therefore, it is now possible to overcome the abovementioned disadvantages; more particularly, it is no longer necessary to merely dispose of the bottoms residues, which brings an advantageous environmental aspect. It has also been found that, surprisingly, particularly the residue from the gas phase phosgenation process is suitable. This residue generally has a relatively low chlorine content; therefore, it is possible to obtain polyurethane foams which additionally meet the demands of IOS-MAT-0010 (IKEA®) or Certipur® in this respect.

### DETAILED DESCRIPTION

To produce the polyurethane foams, the reaction components are reacted by the one-step process known per se or the prepolymer process, often using mechanical means, for example those described in EP-A 355 000. Details of processing equipment which is also an option in accordance with the invention are described in Kunststoff-Handbuch [Plastics Handbook], volume VII, edited by Vieweg and Höchtlen, Carl-Hanser-Verlag, Munich 1993, for example on pages 139 to 265.

The polyurethane foams created by the process according to the invention are preferably in the form of flexible polyurethane foams and may be produced as moulded foams or else as slabstock foams, preferably as moulded foams. The invention further provides a polyurethane foam produced by these processes, a slabstock flexible polyurethane foam or moulded flexible polyurethane foam produced by these processes, and for the use of the flexible polyurethane foams for furniture cushioning, mattresses, automobile seats, headrests, armrests, or as sound-absorbing and/or vibration-damping foams, for example as back-foamed vehicle carpets or sound absorbers in the bulkhead or in the engine compartment.

In a preferred embodiment, the polyurethane foam or flexible polyurethane foam has a formed density, according to DIN EN ISO 3386-1:2010-09, of 5 to 120 kg/m³, preferably 10 to 100 kg/m³, more preferably 20 to 80 kg/m³ and most preferably 40 to 60 kg/m³.

The indeterminate expression “a” generally means “at least one” in the sense of “one or more”. According to the situation, it will be apparent to the person skilled in the art that what must be meant is not the indeterminate article but the determinate article “one”, or that the indeterminate article “a” also encompasses, in one embodiment, the determinate article “one”.

The term “polyurethane foam” is a short form of a polyurethane foam of any type, especially rigid polyurethane foam and flexible polyurethane foam.

If standards such as DIN or ASTM, for example, are used, these are correspondingly always that version which is the current version at the filing date (or priority date if a priority is being claimed and the standards are cited in the priority document), unless another version is explicitly cited.

The components employed in the process according to the invention are more particularly described hereinbelow.

Component A1

The components Al are produced by addition of alkylene oxides onto starter compounds having hydrogen atoms reactive toward isocyanates. These starter compounds usually have functionalities of 2 to 8, preferably of 2 to 6 and more preferably of 2 to 4, and they are preferably hydroxy-functional. Examples of hydroxy-functional starter compounds are propylene glycol, ethylene glycol, diethylene glycol, dipropylene glycol, butane-1,2-diol, butane-1,3-diol, butane-1,4-diol, hexanediol, pentanediol, 3-methylpentane-1,5-diol, dodecane-1,12-diol, glycerol, trimethylolpropane, triethanolamine, pentaerythritol, sorbitol, mannitol, sucrose, hydroquinone, catechol, resorcinol, bisphenol F, bisphenol A, 1,3,5-trihydroxybenzene, methylol-containing condensates of formaldehyde and phenol or melamine or urea. The starter compound used is preferably glycerol and/or trimethylolpropane.

Suitable alkylene oxides are, for example, ethylene oxide, propylene oxide, 1,2-butylene oxide or 2,3-butylene oxide and styrene oxide. Preference is given to feeding propylene oxide and ethylene oxide into the reaction mixture individually, in a mixture or successively. When the alkylene oxides are metered in successively, the products (polyether polyols) produced comprise polyether chains having block structures. Products having ethylene oxide end blocks are characterized, for example, by elevated concentrations of primary end groups which impart advantageous isocyanate reactivity to the systems.

Compounds according to component A1 preferably have a number-average molecular weight of 400 to 18 000 g/mol. Components A1 may optionally have, in addition to the at least two hydroxyl groups, amino groups, thio groups or carboxyl groups. Preference is given particularly to compounds having 2 to 8 hydroxyl groups, especially those having a number-average molecular weight of 1000 to 6000 g/mol, preferably 2000 to 6000 g/mol, for example polyethers having at least 2, generally 2 to 8, but preferably 2 to 6, hydroxyl groups as known per se for the production of homogeneous and cellular polyurethanes, and as described, for example, in EP-A 0 007 502, on pages 8 to 15. Preferably, the polyether polyols are prepared by addition of alkylene oxides (for example ethylene oxide, propylene oxide and butylene oxide or mixtures thereof) onto starters such as ethylene glycol, propylene glycol, glycerol, trimethylolpropane, pentaerythritol, sorbitol, mannitol and/or sucrose, such that it is possible to establish a functionality between 2 and 8, preferably between 2.5 and 6, more preferably between 2.5 and 4.

Component A1 comprises polyether polyols having a functionality of 2 to 8, preferably of 2 to 6, more preferably of 3 to 4, a polyoxyethylene (EO) content of 0% to 30% by weight, preferably of 1% to 20% by weight, and a hydroxyl number according to DIN 53240 of ≥10 mg KOH/g to ≤112 mg KOH/g, preferably of ≥15 to <80 mg KOH/g and more preferably ≥20 mg KOH/g to ≤40 mg KOH/g. The compounds according to A1 may be prepared by catalytic addition of one or more alkylene oxides onto H-functional starter compounds.

Alkylene oxides (epoxides) that may be used are alkylene oxides having 2 to 24 carbon atoms. The alkylene oxides having 2 to 24 carbon atoms are for example one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C₁-C₂₄ esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkoxysilanes, for example 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane, 3-glycidyloxypropyltriisopropoxysilane. Alkylene oxides employed are preferably ethylene oxide and/or propylene oxide and/or 1,2-butylene oxide. Particular preference is given to using an excess of propylene oxide and/or 1,2-butylene oxide and/or ethylene oxide. The alkylene oxides may be supplied to the reaction mixture individually, in admixture or successively. The copolymers may be random or block copolymers. When the alkylene oxides are metered in successively, the products (polyether polyols) produced comprise polyether chains having block structures.

The H-functional starter compounds have functionalities of ≥2 to ≤6 and are preferably hydroxy-functional (OH-functional). Examples of hydroxy-functional starter compounds are propylene glycol, ethylene glycol, diethylene glycol, dipropylene glycol, butane-1,2-diol, butane-1,3-diol, butane-1,4-diol, hexanediol, pentanediol, 3-methylpentane-1,5 -diol, dodecane-1,12-diol, glycerol, trimethylolpropane, triethanolamine, pentaerythritol, sorbitol, sucrose, hydroquinone, catechol, resorcinol, bisphenol F, bisphenol A, 1,3,5-trihydroxybenzene, methylol-containing condensates of formaldehyde and phenol or melamine or urea. Preferably, the starter compound used is 1,2-propylene glycol and/or glycerol and/or trimethylolpropane and/or sorbitol.

The polyether polyols preferably have a number-average molecular weight Mₙ in the range from 62 to 4500 g/mol and especially a number-average molecular weight Mₙ, in the range from 62 to 3000 g/mol, most preferably a molecular weight of 62 to 1500 g/mol.

The weight-average and number-average molecular weight of the polyether polyols (A1 to A3) was determined by means of gel permeation chromatography (GPC). The procedure of DIN 55672-1 was followed: “Gel permeation chromatography (GPC)—Part 1: Tetrahydrofuran (THF) as elution solvent”. Polystyrene samples of known molar mass were used for calibration.

Component A2

The preparation of components A2 is in principle effected in the same way as the preparation of components A1 by addition of alkylene oxides onto starter compounds having hydrogen atoms reactive toward isocyanates as described above.

Component A2 preferably includes at least one polyether polyol having a functionality of 2 to 8, preferably of 2 to 6, more preferably of 3, has a polyoxyethylene (EO) content of >60% by weight, preferably >70% by weight, and has an OH number according to DIN 53240 of ≥10 mg KOH/g to ≤112 mg KOH/g, preferably of ≥20 mg KOH/g to ≤50 mg KOH/g, The proportion of primary hydroxyl groups in A2 is preferably within a range from 40% to 95%, more preferably from 50% to 90%, based on the total number of primary and secondary hydroxyl groups in component A2.

Component A3

Component A3 of the polyether polyol composition A according to the invention is a dispersion of a polymer. Such dispersions are known as polymer-modified polyols and comprise polymer-modified polyether polyols, preferably graft polyether polyols, especially those based on styrene and acrylonitrile, which are advantageously obtained by in situ polymerization of styrene or acrylonitrile or preferably of mixtures of styrene and acrylonitrile (for example in a weight ratio of 90:10 to 10:90, especially of 70:30 to 30:70) in the abovementioned polyether polyols (by methods as described in the following patent specifications: DE 11 11 394, DE 12 22 669, DE 11 52 536, DE 11 52 537, US 3,304,273, US 3,383,351, U.S. Pat. No. 3,523,093, GB 1040452, GB 987618).

Abovementioned dispersions are likewise understood to mean those which are obtained by reaction of diamines and diisocyanates in the presence of a polyol component (PHD dispersions), and/or dispersions containing urethane groups which are obtained by reaction of alkanolamines and diisocyanates in a polyol component (PIPA polyols).

This type of filler-containing polyether polyols according to component A3 (PHD dispersion) are prepared, for example, by in situ polymerization of an isocyanate or isocyanate mixture with a diamine and/or hydrazine in a polyol according to component Al or A2. Preferably, the PHD dispersion is prepared by reacting an isocyanate mixture composed of a mixture composed of 75% to 85% by weight of tolylene 2,4-diisocyanate (2,4-TDI) and 15% to 25% by weight of tolylene 2,6-diisocyanate (2,6-TDI) with a diamine and/or hydrazine. Processes for preparing PHD dispersions are described, for example, in U.S. Pat. No. 4,089,835 and U.S. Pat. No. 4,260,530.

The filler-containing polyether polyols according to component A3 may also be PIPA (polyisocyanate-polyaddition with alkanolamines)-modified polyether polyols, where the polyether polyol has a functionality of 2.5 to 4 and a number-average molecular weight of 500 to 18 000 g/mol.

Compounds of component A3 have an OH number according to DIN 53240 of 10 to 60 mg KOH/g, a hydroxyl functionality of 2 to 6, preferably of 2 to 4, more preferably of 3, a polyoxypropylene (PO) content in an amount of 70% to 90% by weight and a polyoxyethylene content in an amount of 10% to 30% by weight.

Component A4

Component A4 used is 0.5 to 25 parts by weight, preferably 1.0 to 15 parts by weight and more preferably 2 to 5 parts by weight, based on the sum total of the parts by weight of components A1 to A3, of water and/or physical blowing agents. Physical blowing agents used as blowing agents are, for example, carbon dioxide and/or volatile organic substances such as dichloromethane. Preferably, water is used as component A4.

Component A5

Optionally, components A5 used are compounds having at least two hydrogen atoms reactive toward isocyanates and an OH number of 140 mg KOH/g to 900 mg KOH/g. These are understood to mean compounds having hydroxyl groups and/or amino groups and/or thiol groups and/or carboxyl groups, preferably compounds having hydroxyl groups and/or amino groups, which serve as chain extenders or crosslinkers. These compounds generally have 2 to 8, preferably 2 to 4, hydrogen atoms reactive toward isocyanates. For example, components A5 used may be ethanolamine, diethanolamine, triethanolamine, sorbitol, glycerol or a mixture thereof. Further examples of compounds according to component A5 are described in EP-A 0 007 502, on pages 16 and 17. Component A5 is preferably used at 0.1 to 10 parts by weight, more preferably 0.5 to 5 parts by weight, based on the sum total of the parts by weight of components A1 to A3.

Component A6

In the composition according to the invention, it is optionally possible for auxiliaries and additives A6, preferably at least one component selected from catalysts, surface-active additions, additives, pigments, antioxidants and flame retardants or a combination thereof, to be present.

Illustrative surface-active additions (surfactants) are emulsifiers and foam stabilizers, for example products from the Tegostab® series.

Illustrative additives are reaction retardants (for example acidic substances such as hydrochloric acid or organic acyl halides), cell regulators (for example paraffins or fatty alcohols or dimethylpolysiloxanes), dyes, stabilizers against ageing and weathering effects (antioxidants), plasticizers, fungistatic and bacteriostatic substances, fillers (for example barium sulphate, kieselguhr, carbon black or whiting) and separating agents.

These auxiliary and added substances for optional use are described for example in EP-A 0 000 389, on pages 18 to 21. Further examples of auxiliary and added substances for optional use according to the invention and also details concerning ways these auxiliary and added substances are used and function are described in Kunststoff-Handbuch, volume VII, edited by G. Oertel, Carl-Hanser-Verlag, Munich, 3rd edition, 1993, for example on pages 104 to 127.

Catalysts used are preferably aliphatic tertiary amines (for example trimethylamine, tetramethylbutanediamine, 3-dimethylaminopropylamine, N,N-bis(3-dimethylaminopropyl)-N-isopropanolamine), cycloaliphatic tertiary amines (for example 1,4-diaza[2.2.2]bicyclooctane), aliphatic amino ethers (for example bis(dimethylaminoethyl) ether, 2-(2-dimethylaminoethoxy)ethanol and N,N,N-trimethyl-N-hydroxyethylbisaminoethyl e ther), cycloaliphatic amino ethers (for example N-ethylmorpholine), aliphatic amidines, cycloaliphatic amidines, urea, and derivatives of urea (for example aminoalkylureas; see, for example, EP-A 0 176 013, especially (3-dimethylaminopropylamino)urea), and tin catalysts (for example dibutyltin oxide, dibutyltin dilaurate, tin octoate).

Antioxidants which can be used in the production of flexible polyurethane foams are known per se to those skilled in the art. Such compounds are described, for example, in EP-A 1874853, G. Oertel (ed.): “Kunststoff-Handbuch”, volume VII, Carl-Hanser-Verlag, Munich, Vienna 1993, Chapter 3.4.8 or in Ullmann's Encyclopedia of Industrial Chemistry Peter P. Klemchuck, 2012, Vol. 4, p. 162 ff, Wiley VCH-Verlag.

Preferred flame retardants include solid flame retardants (for example melamine and/or ammonium polyphosphate), liquid flame retardants (e.g. halogenated flame retardants, for example tris(2-chloropropyl) phosphate, or halogen-free flame retardants, for example based on oligomeric phosphates, as described, for example, in EP 2687534 and U.S. Pat. No. 4,382,042).

Component A6 is used at 0 to 10 parts by weight of auxiliaries and additions, especially 0.05 to 10.0 parts by weight, preferably 0.1 to 7.5 parts by weight, more preferably 0.2 to 4.0 parts by weight, based in each case on the sum total of 100 parts by weight of components A1 to A3.

Component B

Component B1

Component B1 is obtained as bottoms component in the distillation of crude TDI, as obtained in tolylene diisocyanate (TDI) production in the phosgenation process, especially in the gas phase process in the last distillation step.

The mixture obtained after the distillation contains preferably 30% to 80% by weight of monomeric TDI, more preferably 40% to 75% by weight and most preferably 50% to 70% by weight of monomeric TDI, based on the total weight of component Bl, determined by a distillation method as follows:

50 g of the TDI residue mixture (=bottoms component) are weighed into a 250 ml one-neck flask. The flask is inserted into a distillation apparatus as bottoms flask. This is followed by heating to 250° C. and distillation under reduced pressure (<3 mbar). After 30 minutes, the distillation has ended. After cooling, the dry residue is reweighed.

The NCO content of the mixture obtained after distillation (determined according to ASTM D 5155/B) is preferably 30% to 45%, more preferably 34% to 39.4%.

The distillation residues are residues from the distillation in the production of tolylene diisocyanate (TDI), a main component for production of polyurethane. The preparation of isocyanates is effected by phosgenation of corresponding amines, by reacting the reactants in a solvent, usually ortho-dichlorobenzene. The reaction proceeds with a yield of about 95% to 97%, the by-products formed being primarily isocyanate polymers. Gas phase phosgenation processes, which generally do not need solvent in the reaction, achieve yields of about 96%-99%. To obtain pure isocyanates, the crude isocyanate solution obtained by phosgenation is distilled in a number of component steps. The bottom product obtained from the distillation columns is a residue solution which, in the case of production of TDI, contains about 5% to 20% polymeric TDI. The residue solution thus obtained is then concentrated further in a falling-film evaporator by further distillative removal of TDI, such that the residue concentration can be increased to 30% to 60%. The falling-film evaporator is operated at 30 to 50 mbar and 140 to 175° C.

Component B2

Components B2 used are one or more aliphatic, cycloaliphatic, araliphatic, aromatic and heterocyclic di- or polyisocyanates, as described, for example, by W. Siefken in Justus Liebigs Annalen der Chemie, 562, pages 75 to 136, for example those of the formula (I)

Q(NCO)n (I)

in which

n=2 to 4, preferably 2 to 3, and

Q is an aliphatic hydrocarbon radical having 2 to 18 and preferably 6 to 10 carbon atoms, a cycloaliphatic hydrocarbon radical having 4 to 15 and preferably 6 to 13 carbon atoms, or an araliphatic hydrocarbon radical having 8 to 15 and preferably 8 to 13 carbon atoms.

The polyisocyanates are for example those described in EP-A 0 007 502, pages 7 and 8.

Preference is generally given to the readily industrially available polyisocyanates, for example tolylene 2,4- and 2,6-diisocyanate and any desired mixtures of these isomers (“TDI”); polyphenyl polymethylene polyisocyanates as prepared by aniline-formaldehyde condensation and subsequent phosgenation (“crude MDI”), and polyisocyanates having carbodiimide groups, urethane groups, allophanate groups, isocyanurate groups, urea groups or biuret groups (“modified polyisocyanates”), especially those modified polyisocyanates which derive from tolylene 2,4- and/or 2,6-diisocyanate or from diphenylmethane 4,4′- and/or 2,4′-diisocyanate. The polyisocyanate used is preferably at least one compound selected from the group consisting of 2,4- and 2,6-tolylene diisocyanate, 4,4′- and 2,4′- and 2,2′-diphenylmethane diisocyanate and polyphenyl polymethylene polyisocyanate (“polynuclear MDI”) and mixtures thereof. In even more preferred embodiments, this mixture has a dinuclear content of >50%.

The dinuclear content can be determined as follows. The sample is dissolved in toluene and the contents of the MDI isomers or the sum total of the monomers is determined by means of gas chromatography with n-tetracosane as internal standard. Gas chromatograph: for example Agilent 6890 with flame ionization detector, autosampler and Agilent Chemstation. The gas chromatography conditions are as follows: The separation column is, for example, an OV-I type quartz capillary column, e.g. Varian CP 8735, internal diameter 0.53 mm, film thickness 1.5 pm, length 30 m. The temperatures are: injector 300° C., detector 310° C., column oven start temperature 160° C., heating rate 20° C./min, end temperature 300° C. The carrier gas is nitrogen, with gas flow rate 16.8 ml/min, splitless, purge rate 35 ml/min. The combustion gas is hydrogen, 40 ml/min, oxidant: air, 400 ml/min. The injection volume is 1.0 pl. The analysis time is about 49 min The retention times: 2,2′-MDI' about 6.3 min, 2,4′-MDI about 6.8 min, 4,4′-MDI about 7.1 min and internal standard about 8.6 min

In a preferred embodiment of the invention, a reaction mixture for B2 composed of diphenylmethane 4,4′- and 2,4′- and 2,2′-diisocyanate and polyphenyl polymethylene polyisocyanate (“polynuclear MDI”) and mixtures thereof is used. In a further preferred embodiment of the invention, a reaction mixture for B2 composed of tolylene 2,4- and 2,6-diisocyanate, diphenylmethane 4,4′- and 2,4′- and 2,2′-diisocyanate and polyphenyl polymethylene polyisocyanate (“polynuclear MDI”) is used.

In a further preferred embodiment of the process according to the invention the isocyanate component B2 comprises a tolylene diisocyanate isomer mixture composed of 45% to 90% by weight of 2,4-TDI and 10% to 55% by weight of 2,6-TDI.

In a further embodiment of the process according to the invention, the index is 75 to 120, preferably 80 to 115, more preferably 85 to 95.

The index indicates the percentage ratio of the amount of isocyanate actually used to the stoichiometric amount of isocyanate groups (NCO), i.e. that calculated for the conversion of the OH equivalents:

Index=[(amount of isocyanate used):(amount of isocyanate calculated)·100]

The polyurethane foams, preferably flexible moulded polyurethane foams, obtainable according to the invention find use for example in: furniture cushioning, mattresses, automobile seats, headrests, armrests, and as sound-absorbing and/or vibration-damping foams, for example back-foamed vehicle carpets or sound absorbers in the bulkhead or in the engine compartment.

The present invention is elucidated hereinafter with reference to working examples.

### EXAMPLES

(Polyol) component A1: Polyether polyol having an OH number of about 28 mg KOH/g, prepared by means of KOH-catalysed addition of propylene oxide and ethylene oxide in a weight ratio of 85 to 15 using glycerol as starter compound, and with about 85 mol% of primary OH groups.

(Polyol) component A2: Polyether polyol having an OH number of about 37 mg KOH/g, prepared by means of KOH-catalysed addition of propylene oxide and ethylene oxide in a weight ratio of 27 to 73 using glycerol starter compound, about 83 mol% of primary OH groups.

(Polyol) component A3: Dispersion composed of 40% of an SAN (styrene/acrylonitrile) polymer with a styrene/acrylonitrile ratio of 65:35 in a polyether polyol, with an OH number according to DIN 53240 of 20 mg KOH/g, where the polyether polyol has a nominal hydroxyl functionality of 3, a polyoxypropylene (PO) content of 80% by weight and an EO content of 20% by weight.

Niax ® A-1: amine catalyst from Momentive

Niax @A-33amine catalyst from Momentive

Tegostab® B 8715: silicone stabilizer from Evonik

DEOA: diethanolamine

(B2.1): mixture of B2.2 and B2.3 in a ratio of 80:20 parts by weight.

(B2.2): mixture of tolylene 2,4- and 2,6-diisocyanate with a proportion of the 2,4 isomer of 80% and an NCO content of 48%.

(B2.3): mixture of monomeric and polymeric diphenylmethane diisocyanates having a total monomer content of about 45%, a 4,4′ content of about 40%, a 2,4′ content of about 4%, a 2,2′ content of <0.2% and a content of higher polynuclear oligomers of about 55%.

Residue (B1.1): has a content of monomeric TDI of 70% by weight by the above-described distillation method, an NCO content of 39.37% by weight and a viscosity of 243 mPas at 25° C., measured by means of method DIN 53015.

Residue (B1.2): has a content of monomeric TDI of 50% by weight by the above-described distillation method, an NCO content of 34.00% by weight and a viscosity of 3779 mPas at 72° C., measured by means of method DIN 53015.

Polyurethane foams were produced according to the formulations specified in Table 1 below. The proportions of the components are listed in parts by weight.

Hydroxyl number was determined according to DIN 53240:2012-07.

Formed density and compression hardness were determined according to DIN EN ISO 3386-1:2010-09.

Tensile strength and elongation at break were determined to DIN EN ISO 1798:2008-04.

Ball rebound resilience was determined according to DIN EN ISO 8307:2007.

Indentation hardness, recovery, air flow and IFD return value were determined according to ASTM D 3574.

Tear propagation resistance was determined to DIN EN ISO 8067:2009-06.

Compression set (C.S.) was determined according to ASTM D 3574.

Burn length and burn rate were determined in accordance with Federal Motor Vehicle Safety Standard 302, ISO 3795.

TABLE 1
Polyurethane foams (CE = comparative example, IE = inventive example, n.d. = not determined)

| Compounds | CE 1 | IE 2 | CE 3 | IE 4 | CE 5 | IE 6 | CE 7 | IE 8 | CE 9 | IE 10 | CE 11 | IE 12 |
|---|---|---|---|---|---|---|---|---|---|---|---|---|
| Component A1 | 60 | 60 | 65 | 65 | 65 | 65 | 65 | 65 | 65 | 65 | 65 | 65 |
| Component A2 | 1 | 1 | 1.5 | 1.5 | 1.5 | 1.5 | | | | | | |
| Component A3 | 40 | 40 | 35 | 35 | 35 | 35 | 35 | 35 | 35 | 35 | 35 | 35 |
| Water (A4) | 3.2 | 3.2 | 3.2 | 3.2 | 3.2 | 3.2 | 3.2 | 3.2 | 3.2 | 3.2 | 3.2 | 3.2 |
| Glycerol (A5) | | | | | 0.5 | 0.5 | | | | | 0.5 | 0.5 |
| Niax A-1 catalyst | 0.12 | 0.12 | 0.1 | 0.15 | 0.1 | 0.15 | 0.15 | 0.1 | 0.15 | 0.15 | 0.15 | 0.15 |
| Niax A-33 catalyst | 0.48 | 0.6 | 0.4 | 0.6 | 0.4 | 0.6 | 0.6 | 0.6 | 0.6 | 0.6 | 0.6 | 0.6 |
| Diethanolamine | | | 1.5 | 1.5 | | | 1.5 | 1.5 | | | | |
| B8715 stabilizer | 0.5 | 0.5 | 1 | 1 | 1 | 1 | 1 | 1 | 1 | 1 | 1 | 1 |
| Isocyanate (B2.1) | 35.51 | | | | | | | | | | | |
| Isocyanate (B2.2) | | 28.4 | 31.60 | 20.47 | 29.67 | 19.25 | 36.62 | 30.34 | 33.08 | 24.42 | 34.43 | 22.2 |
| Isocyanate (B2.3) | | 3.55 | 7.90 | 4.09 | 7.42 | 3.85 | | | | | | |
| Residue (B1.1) | | | | 16.38 | | 15.40 | | 7.59 | | 10.46 | | 14.8 |
| Residue (B1.2) | | 3.55 | | | | | | | | | | |
| Index | 95 | 95 | 95 | 95 | 95 | 95 | 95 | 95 | 95 | 95 | 95 | 95 |
| Properties | | | | | | | | | | | | |
| Formed density, | 50.45 | 50 | 54.8 | 55.9 | 56.0 | 55.1 | 56.1 | 55.0 | 56.3 | 55.6 | 54.4 | 55.7 |
| kg/m3 | | | | | | | | | | | | |
| Core foam density, | 43.71 | 43.53 | 54.1 | 52.8 | 52.5 | 51.6 | 47.6 | 51.0 | 55.4 | 53.8 | 48.3 | 52.3 |
| kg/m3 | | | | | | | | | | | | |
| Ball rebound | 64 | 60 | 61 | 64 | 60 | 64 | 61 | 61 | 47 | 57 | 54 | 57 |
| resilience, % | | | | | | | | | | | | |
| Indentation | 212.5 | 228.93 | 243.0 | 252.2 | 248.1 | 258.3 | 214.3 | 260.3 | 302.2 | 330.0 | 249.5 | 336 |
| hardness 25%, N | | | | | | | | | | | | |
| Indentation | 565.96 | 605.52 | n.d. | n.d. | n.d. | n.d. | n.d. | n.d. | n.d. | n.d. | n.d. | n.d. |
| hardness 65%, N | | | | | | | | | | | | |
| Compression | 9.56 | 10.63 | 11.53 | 13.1 | 12.8 | 12.97 | 10.59 | 13.29 | 18.78 | 17.15 | 13 | 15.49 |
| hardness 40%, kPa | | | | | | | | | | | | |
| IFD return value | 175.12 | 180.45 | n.d. | n.d. | n.d. | n.d. | n.d. | n.d. | n.d. | n.d. | n.d. | n.d. |
| 25%, N | | | | | | | | | | | | |
| Sag factor (calc. | 2.66 | 2.65 | n.d. | n.d. | n.d. | n.d. | n.d. | n.d. | n.d. | n.d. | n.d. | n.d. |
| from indentation | | | | | | | | | | | | |
| hardness at 25% | | | | | | | | | | | | |
| and 65%) | | | | | | | | | | | | |
| Recovery % | 82.41 | 78.82 | n.d. | n.d. | n.d. | n.d. | n.d. | n.d. | n.d. | n.d. | n.d. | n.d. |
| Air flow, l/min | 99 | 95 | 32 | 52 | 21 | 43 | 28 | 24 | 7 | 16 | 15 | 20 |
| Tensile strength, | 154.8 | 152.5 | 169 | 218.5 | 214.2 | 215 | 202.6 | 209.25 | 256.2 | 221 | 205.6 | 257.6 |
| kPa | | | | | | | | | | | | |
| Elongation at | 112 | 123.18 | 102 | 110.7 | 118.1 | 122.44 | 120.88 | 117.05 | 183.94 | 139.96 | 153.4 | 156 |
| break, % | | | | | | | | | | | | |
| Tear propagation | 437.55 | 466.04 | 262.47 | 377.96 | 366.38 | 414.77 | 376.51 | 406.43 | 787.46 | 663.8 | 520.39 | 579.15 |
| resistance, N/m | | | | | | | | | | | | |
| ISO 8067 | | | | | | | | | | | | |
| C.S. 70% (22 hours, | 6.8 | 8.02 | 7.51 | 5.73 | 7.95 | 8.66 | 37.1 | 7.26 | 15.75 | 10.18 | 19.99 | 12.35 |
| 70° C.) | | | | | | | | | | | | |
| FMVSS 302 Test; | n.d. | n.d. | pass | n.d. | n.d. | n.d. | fail | pass | fail | pass | fail | pass |
| burn length mm | | | | | | | | | | | | |
| (fail ≥254 mm) | | | | | | | | | | | | |
| FMVSS 302 Test; | n.d. | n.d. | fail | n.d. | n.d. | n.d. | fail | pass | n.d. | pass | n.d. | pass |
| burn rate mm/min | | | | | | | | | | | | |
| (fail ≥102 mm/min) | | | | | | | | | | | | |
| FMVSS 302 test | n.d. | n.d. | no | n.d. | n.d. | n.d. | no | yes | no | yes | no | yes |
| requirement | | | | | | | | | | | | |
| fulfilled | | | | | | | | | | | | |

Example 2, in comparison with noninventive Example 1, shows that, in the case of partial replacement of the MDI component in a standard commercial cold-cure foam formulation based on what is called a VT isocyanate (mixture of 80% TDI and 20% p-MDI) by the highly concentrated TDI residue mixture, it is possible to obtain a foam of good quality, or even of improved quality in relation to elongation at break, tear propagation resistance and compression hardness.

Further experiments were conducted with a residue mixture which contained 70% monomeric TDI and was easier to handle because of its lower viscosity:

Example 4, compared to Comparative Example 3, showed that, in the case of partial replacement of the p-MDI components in a standard commercial VT system (mixture of TDI T80 and p-MDI with an NCO content of 44.8% and a viscosity at 25° C. about 6 mPas), with comparable foam density and hardness, there is a rise (improvement) in ball rebound resilience and also an improvement in further mechanical properties such as tensile strength, elongation at break and tear propagation resistance (all values increase). At the same time, the use of the TDI residue has a positive effect on compression set (value is reduced). As Example 6 by comparison with Comparative Example 5 shows, these improvements, except for the compression set, also remain in the case of concomitant use of 0.5 part glycerol, which is often used in industry to improve stability or to somewhat delay the onset of the reaction.

Example 8, by comparison with Comparative Example 7, this time in a purely T80-based formulation, shows the positive effects of the partial concomitant use of the residue. Here too, there is a slight increase in hardness and an improvement in all other properties, except for the ball rebound resilience which remains about the same. Surprisingly, the foam of the patent according to Example 8 also meets the fire requirements according to MVSS 302 even without further addition of a flame retardant, whereas the foam of Comparative Example 7 far exceeds the burn rate of max. 100 mm/min with 133 mm/min and therefore fails the test.

This improvement in fire characteristics is also confirmed by the foams of Inventive Example 10 by comparison with Comparative Example 9, in which again a purely T80-based formulation, but this time without addition of DEOA, was used in order to arrive at higher foam hardnesses overall.

If glycerol is again used in place of DEOA as crosslinker, this effect is maintained and a general improvement in the mechanical foam properties is obtained, as shown by Example 12 compared to Comparative Example 11.

It has surprisingly been shown in the examples that it is possible to obtain a polyurethane foam having similar or even improved properties, especially improved fire characteristics, even though a bottoms residue obtained in tolylene diisocyanate (TDI) production in the phosgenation method has been used in part.

1. A process for producing polyurethane foams by reacting a component A comprising
A1 at least one polyether polyol having a functionality of 2 to 8, a polyoxyethylene (EO) content of 0% to 30% by weight, and an OH number according to DIN 53240 of ≥10 mg KOH/g to ≤112 mg KOH/g,
A2 optionally,. at least one polyether polyol having a functionality of 2 to 8, a polyoxyethylene (EO) content of >60% by weight, and an OH number according to DIN 53240 of ≥10 mg KOH/g to ≤112 mg KOH/g,
A3 optionally, at least one dispersion of a polymer in a polyether polyol, where the OH number according to DIN 53240 of the dispersion is within a range from 10 to 60 mg KOH/g and wherein the polyether polyol has a hydroxyl functionality of 2 to 6, a polyoxypropylene (PO) content in an amount of 70% to 90% by weight and an EO content in an amount of 10% to 30% by weight;
A4 water and/or physical blowing agents,
A5 optionally, compounds having hydrogen atoms that are reactive toward isocyanates, having an OH number of 140 mg KOH/g to 900 mg KOH/g,
A6 optionally, auxiliaries and additives, preferably at least one component selected from catalysts, surface-active additions, additives, pigments or flame retardants or a combination thereof;
and a component B comprising
B1 the distillation product of at least one bottoms residue which is obtained in tolylene diisocyanate (TDI) production, in the last distillation step,
B2 further di- and/or polyisocyanates,
wherein the reaction of component A with component B is conducted at an isocyanate index of 75 to 120, and wherein all parts by weight figures for components A1 to A6 are normalized such that the sum total of parts by weight A1+A2+A3 in the composition adds up to 100 parts by weight.

2. The process according to claim 1, wherein component A comprises
10 to 100 parts by weight, of A1;
0 to 10 parts by weight, of A2;
0 to 80 parts by weight of A3,
wherein the sum total of A1 to A3 is 100 parts by weight.

3. The process according to claim 1, wherein
0.5 to 25 parts by weight of A4; and/or
0.1 to 10 parts by weight of A5,
based on 100 parts by weight of the sum total of A1 to A3.

4. The process according to claim1, wherein 0.05 to 10 parts by weight of A6 are present, based on 100 parts by weight of the sum total of A1 to A3.

5. The process according to claim1, wherein A6 comprises one or more catalysts, surface-active additions, additives, pigments, antioxidants, flame retardants or a combination thereof.

6. The process according to claim 1, wherein B1 is present at 10% to 80% by weight, based on the total weight of B.

7. The process according to claim 1, wherein the chlorine content of B1 is <750 ppm.

8. The process according to claim 1, wherein said distillation product of at least one bottoms residue B1 is obtained in the last distillation step of a gas phase production process of tolylene diisocyanate (TDI).

9. The process according to claim 1, wherein B2 comprises tolylene-2,4-diisocyanate, tolylene2,6-diisocyanate, diphenylmethane-4,4′-diisocyanate, diphenylmethane-2,4′-diisocynate, diphenylmethan-2,2′-diisocyanate, polyphenyl polymethylene polyisocyanate (“polynuclear MDI”), or mixtures thereof.

10. The proccss according to claim 9, wherein the mixtures have a dinuclear content >50%.

11. A polyurethane foam obtainable by a process according to claim 1.

12. The polyurethane foam according to claim 11, wherein the polyurethane foam has a formed density, measured to DIN ISO 3386-1:2010-09, of 5 to 120 kg/cm³.

13. The polyurethane foam according to claim 11, wherein the polyurethane foam has a ball rebound resilience to DIN EN ISO 8307:2007 of 0% to 70%.

14. An article comprising the polyurethane foam according to claim 11 in furniture, bedding, automotive, or for sound-absorption or vibration-damping.
